(19) United States
(12) Patent Application Publication
(10) Pub. No.: US 2015/0046236 A1
(43) Pub. Date: Feb. 12, 2015

(54) SYSTEM FOR FACILITATING AND REWARDING PARTING WITH GOODS AND SERVICES

(71) Applicant: GIVINGAWAY WORLDWIDE CORPORATION, Long Island City, NY (US)

(72) Inventor: Roman Boulman, Long Island City, NY (US)

(21) Appl. No.: 14/454,229

(22) Filed: Aug. 7, 2014

Related U.S. Application Data
(60) Provisional application No. 61/864,218, filed on Aug. 9, 2013.

(51) Int. Cl. G06Q 30/02; G06Q 10/08

(52) U.S. Cl. CPC G06Q 30/0208; G06Q 10/083
USPC 705/14.11

(57) ABSTRACT

A new computer based economic model is disclosed which relies on users to donate or give away at a low cost material things or services in exchange for discounts on goods. In one embodiment, a person posts an old item, gives the old item away, buys a new item and gets a rebate within predetermined time period.

### PRIORITY

This application is a continuation of and claims priority to U.S. Provisional Patent Application No. 61/864,218, filed Aug. 9, 2013, all of which is incorporated by reference.

### BACKGROUND

Consumer based societies have more good than they need. Often, consumers realize they have too many material things, but feel bad about discarding the goods as they may have paid for the goods, they do not have a good place to donate the goods, the good may be too hard to move or the user may not want untrusted people in reviewing the goods or services.

### SUMMARY

A new computer based economic model is disclosed which relies on users to donate or give away at a low cost material things or services in exchange for discounts on goods. In one embodiment, a person posts an old item, gives the old item away, buys a new item and gets a rebate within predetermined time period. In another embodiment. a person may posts an old item, buy a new item, gives the old item away and gets a rebate. In yet another embodiment, a person may buy a new item, post an old item to be given away, gives the old item away and gets a rebate. The rebate may take on a variety of forms from discount percentages to monetary grants.

In addition, the model may provide for a computerized manner of arranging for delivery. The pickup point and delivery point along with a description may be provided to a plurality drivers and the drivers can bid on the driving assignment. In addition, reviews of the drivers may be available and the shipper may be able to select the desired driver based on price and reviews in real time.

### BRIEF DESCRIPTION OF THE DRAWINGS

FIG. 1 is a logic flow used in the computing system;

FIG. 2 is an illustration of a sample display of offering a good;

FIG. 3 is an illustration of a sample display of reviewing items available;

FIG. 4 is an illustration of a method of finding a delivery person;

FIG. 5 is an illustration of entering delivery information;

FIG. 6 may illustrate an input screen for common moving quotes;

FIG. 7 is an illustration of reviewing delivery quotes;

FIG. 8 is illustration of a display of an acceptance by the second person of a quote;

FIG. 9 is an illustration of a delivery information code;

FIG. 10 is an illustration of a reward display;

FIG. 11 is a high level illustration of a computer system;

FIG. 12 is an illustration of a server based computing system ; and

FIG. 13 is an illustration of a portable computing system.

### DESCRIPTION

A computerized system and method of accepting an item for virtually no cost and offering a reward in exchange is disclosed. Currently, people have a significant accumulation of goods and not all of the goods are needed. For numerous reasons, the people are hesitant to get rid of excess goods, including the challenge of moving the goods and the challenge of getting rid of the goods. The system causes virtually no stress and may have some positive impact on the person making the donation.

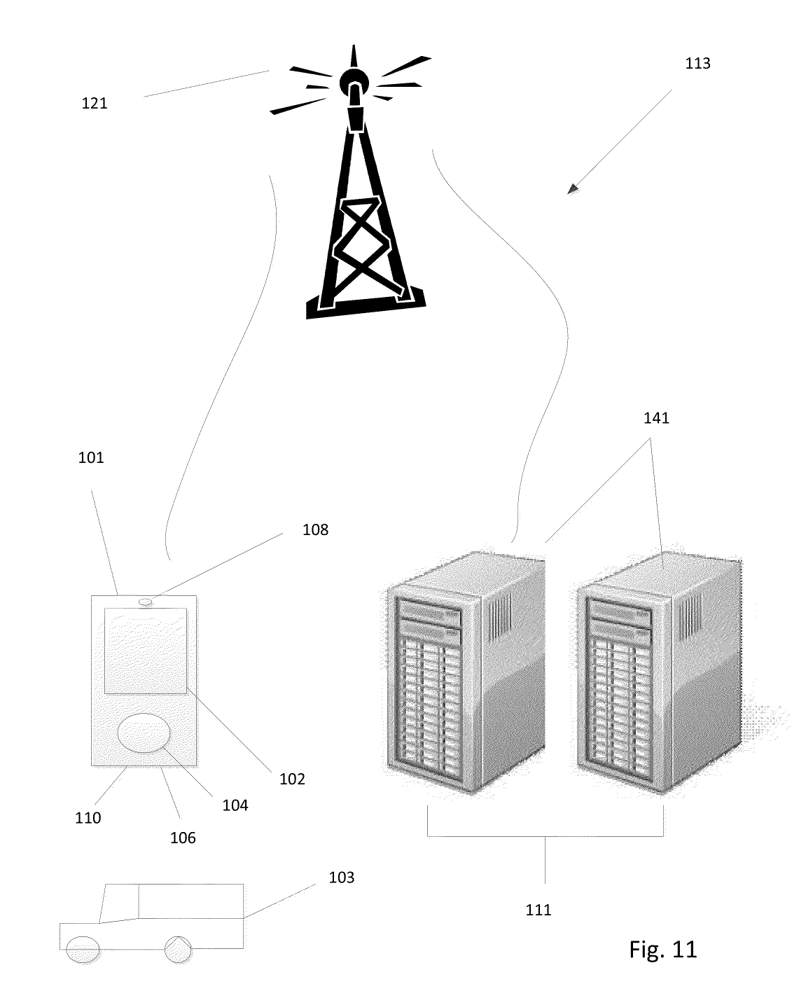

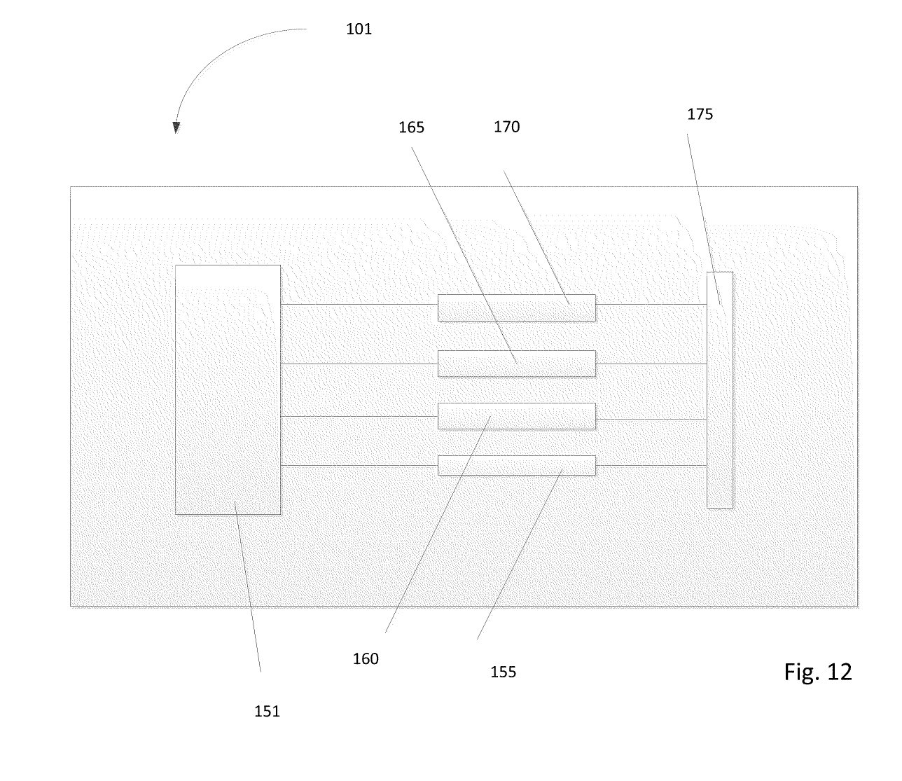

The method may be executed on a purpose built computer system 113 such as the computer illustrated in FIGS. 11, 12 and 13 which may track the items, users, deliveries, money, credits, debits and other transactions. The computer system 113 may take on a variety of forms. In some embodiments, there may be a single computer 141. In other embodiments, a series of computers 141 may be networked together. In yet another embodiment, a cloud of computing devices 111 may be used. Further, portable computing devices 101 such as illustrated in FIG. 12 may be used as part of the computing system

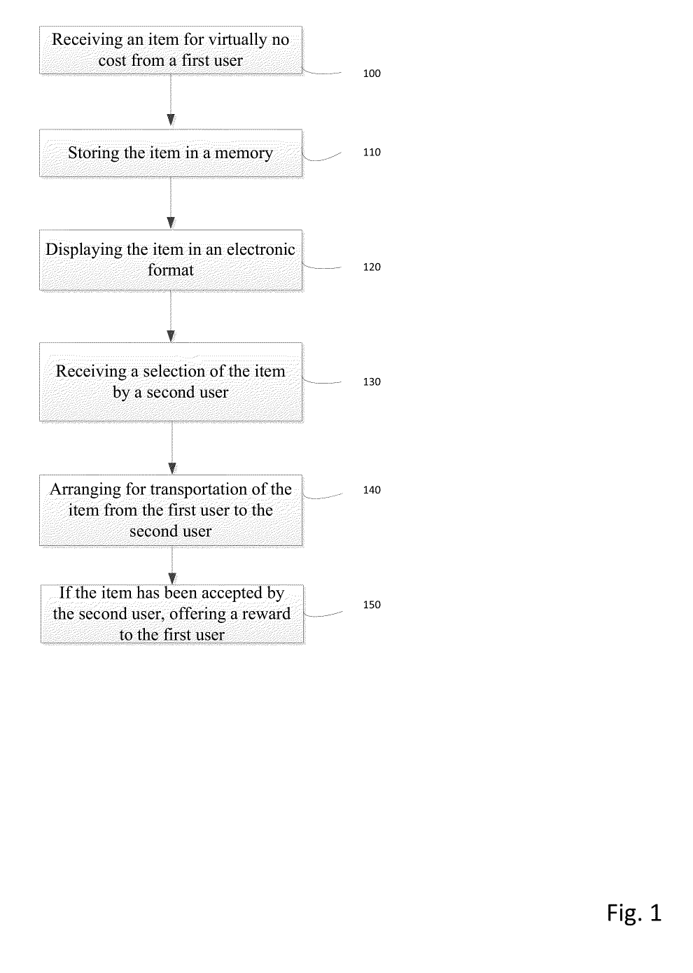

Referring to FIG. 1, at block 100, an item 300 may be received for virtually no cost from a first user. In some embodiments, the item 300 may be completely free such as a donation. In another embodiment, the first user may receive a nominal fee for the item 300. The word “donation” may be used to mean both free and for a nominal fee. Certainly, if the item 300 cost $1 and is worth $100, either when new or currently, the system 113 is design to facilitate the transfer of such an item 300 as the transaction would be properly considered to fall under the virtually no fee description.

The item 300 may be virtually any good or service. In one embodiment, a first person may be moving to a new city and it may not make sense to move heavy furniture and/or smaller items. The first person may prefer to donate their large belongings and buy new belongings in the next city. In another embodiment, the first person may simply be tired of an item 300 and may wish to donate it to buy something different or better. The described system and method would make donating an item 300 easier, would make the first person feel better than having the item enter a landfill or having a series of stranger come examine the article. Plus, receiving a reward/discount will encourage the first user to use the system, providing a tangible, valuable benefit for the donation of time, services and an item.

In addition, services may be considered items 300 and be part of the system. If a first person has free time, the time may be donated or provided for free or for a very low fee and may result in a reward being earned. For example, a CPA may offer to create tax returns for free or a low fee and a reward may be granted if a second user selects to use the tax preparation services.

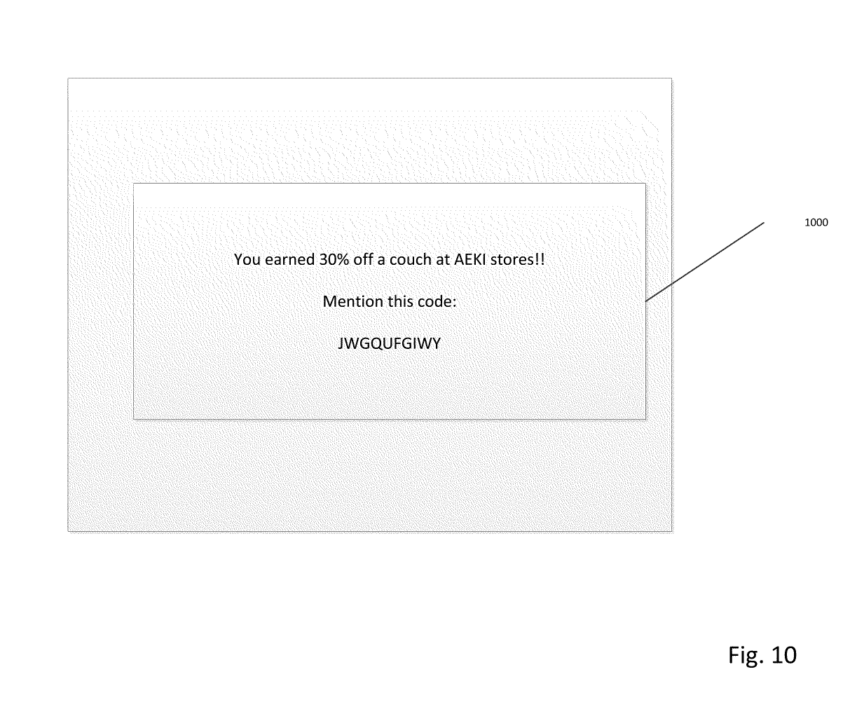

In some embodiments, a reward 1000 (FIG. 10) may be issued upon posting item 300 for free or virtually no fee. As there may be an incentive to list many items 300 in the hopes of collecting many discounts, the system 113 may take steps to reduce the incentive. As one example, the reward 1000 may be very small. In another example, there may be limits on the reward 1000 such as one reward 100 per quarter. In other embodiments, no reward 1000 is offered until an item 300 is accepted by a second party.

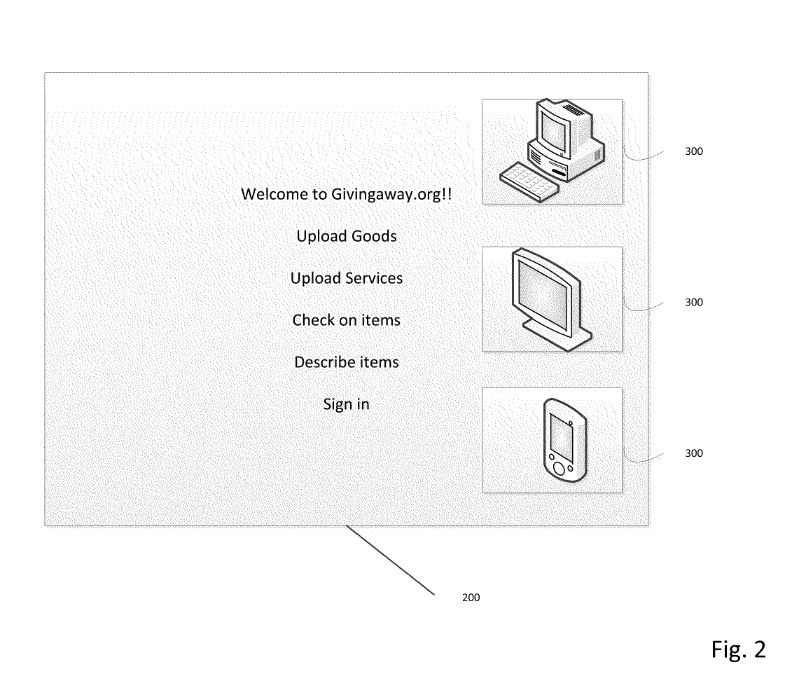

The posting may take on a variety of forms. In one embodiment, one or more photos of the item 300 may be upload as illustrated in FIG. 2 in a upload display 200. In another embodiment, such as when an entire room is offered, the first party may set up the room layout online and place the items 300 in the layout where the items 300 may be hovered over or selected for additional views. Further, addition detail about the item may be added such as weight, length, manufacturer, resume of service provider, testimonials, rating of the other items 300 from the first person, ratings of the specific goods or services as donated by others, etc. The additional information may be text or may be linked to other networked sites such as internet sites. In yet another embodiment, video of the goods or services may be upload for review by second users. In another embodiment, person to person video may be used to allow a second person to directly view the goods or services through a computing device of the first person. Of course, online help assistance may be available throughout the process. In addition, help wizards may be created and be available as are videos that walk a user through all of the processes, from uploading item, to selecting items 300 to finding movers and to using rewards.

At block 110, the item may be stored in a memory. The memory may be any memory 310, 315 as described in reference to the computing device 141, such as on a hard drive, in a flash drive, on a tape drive, on several memories spread across a cloud of storage devices 110, etc. The item 300 may be stored in a manner such that the image may be quickly and easily communicated across a network to a variety of users.

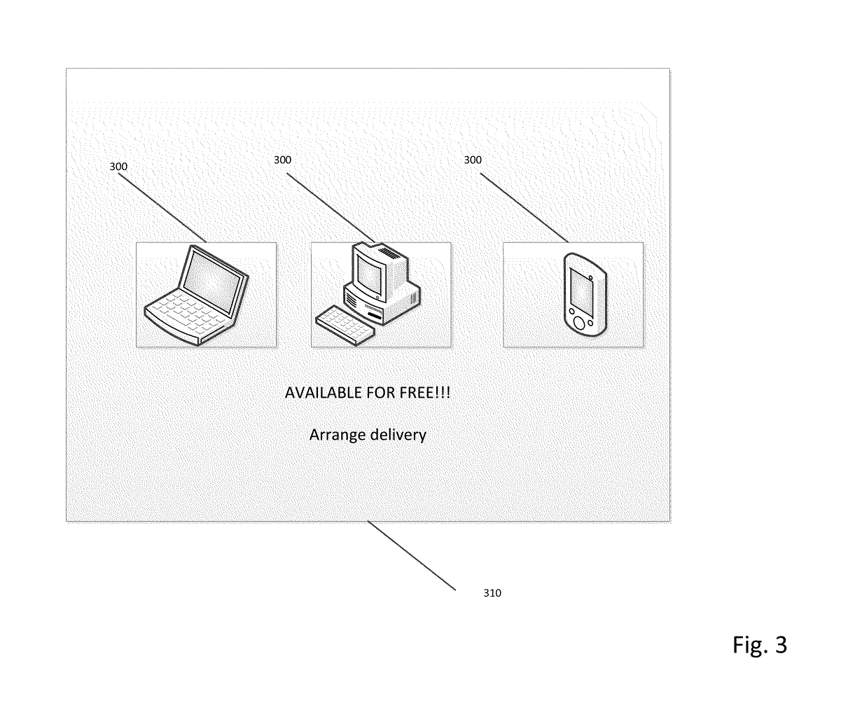

At block 120, the items 300 may be displayed in an electronic format. FIG. 3 may be a sample display. As mentioned previously, the display 310 may take on a variety of forms depending on the visual material uploaded. If a picture is upload, the display 310 may be of a picture and if a video is uploaded, the video may be reviewed. In addition, if additional details were provided, the additional details may be selected and viewed as the display 310. In some instances, the second party may be able to request a person to person review where the first person may carry a camera around and highlight the condition of the item 300. Logically, if a diagram of a space is provided, a user may browse through the space, hover over items 300 to obtain additional media about the items 300 (images, videos, sounds, statistics) or select the items 300 to obtain the additional information.

The format of the display 310 make take on a variety of forms. In one embodiment, the items 300 may be segregated by price. In addition, the items 300 may be separated by category or keyword. In another embodiment, the display may be separated by the date the items 300 were added. In addition, the items 300 may be listed alphabetically. The system 113 may also review the photos and description and classify the item itself. Further, the system 113 may review past searches by user and suggest items 300 to users based on their search history. The system 113 may also review the postings for accuracy. For example, if a user is donating a Ferrari, the photos may be analyzed to ensure the photos are of a Ferrari.

At block 130, an item 300 may be selected to be received by the second user. In some embodiments, the second user may need to be a registered user such that false purchase may be limited. In some embodiments, once the item 300 is selected to be received, the items 300 may disappear from the system . In other embodiments, the goods or services may appear to be on hold to other viewers of the site. In some embodiments, a payment for shipping the goods or services may be necessary to hold the item 300 or to have the item 300 removed from other viewer of the system 113.

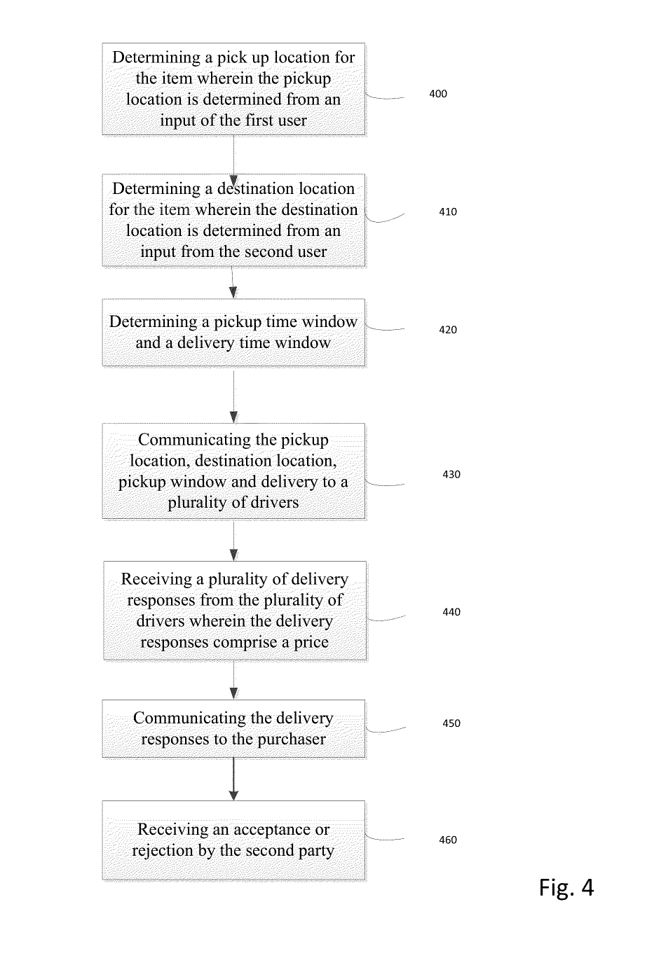

At block 140, transportation of the item 300 from the first user to the second user may be arranged. FIG. 4 may be an illustration of logic used to find a delivery person. At block 400, a pick up location for the item 300 may be determined where the pickup location is determined from an input of the first user. Logically, the pickup location may be set by the first user. In some instances, the second user may request the pickup location be adjusted but it is up to the first user to accommodate the second user.

At block 410, a destination location for the item 300 may be determined. The destination location may be determined from an input from the second user. The destination location may be significantly different than the pickup location, such as across the country. On the other hand, the location may be very close such as the next building over. Some items 300 are simply hard to move and it may be easier to donate or sell them for a small amount of money than to move them.

At block 420, a pickup time window and a delivery time window may be determined. Logically, the pickup time will be when the first person is available to be home and the delivery time logically should be at a time when the second person is home.

At block 430, the pickup location, destination location, pickup window and delivery may be communicated to a plurality of drivers. The drivers may then review the data and determine a price to make the pickup and the delivery. All the information may be relevant to the drivers. If the pickup time is at an inconvenient time, the driver may quote a higher price. Similarly, if the driver already has a project during the preferred time window and the driver would have to re-arrange the schedule, then the price may be higher. Likewise, if the delivery person is low on work and has time available, the quote may be lower. As is understood, the law of supply and demand may make the price change based on a variety of factors.

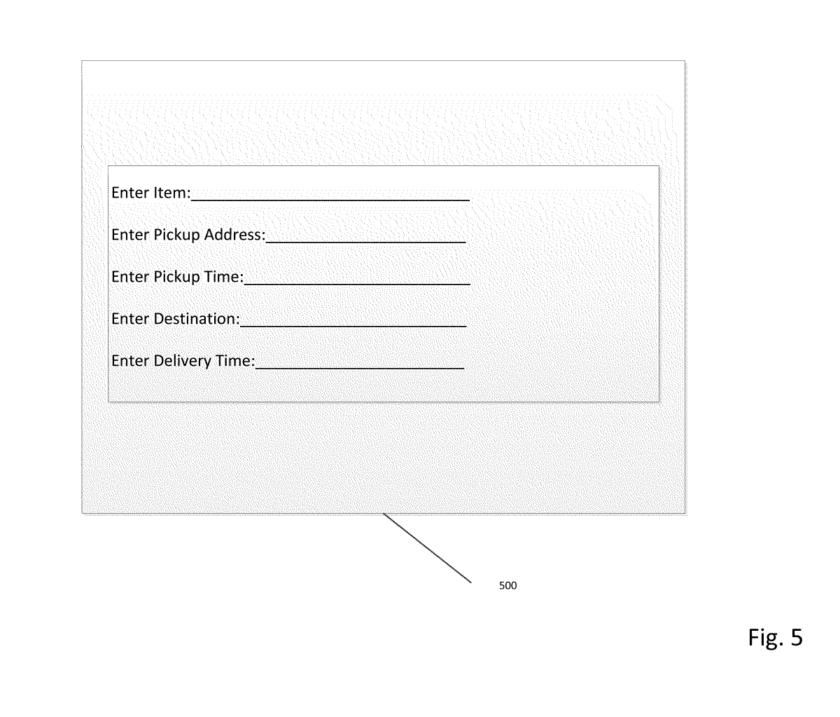

FIG. 5 may be an illustration of a display 500 for entering delivery information. As mentioned in reference to FIG. 4, a variety of fields may be filled in to provide the minimum information such that the drivers may intelligently bid on providing the pickup and delivery service. In some embodiments, some information may be optional and some may be mandatory. For example, a delivery address may be mandatory while the size of an available elevator may be optional.

In some embodiments, the system may have a moving database on the address with information that is relevant to moving. For example, the address 123 Maple may bring up the data that the house is a single story house with two steps, a 36 inch wide front door and no parking restrictions. Similarly, a high rise may have the information on available parking, service elevators, superintendents, helpful doormen, doorway sizes, availability of the service elevator, etc. Photos, videos, maps and illustrations may also be included. The moving database may grow over time as moving and system users add data to the system.

At block 440, a plurality of delivery responses may be received from the plurality of drivers. The responses may be reviewed to be sure the responses make logical sense. For example, if a move is over two thousand miles and the quote is for $10, there likely is a problem with the quote. A set of rules may be developed to ensure the quotes make sense and the rules may develop and change over time as circumstances change. For example, a significant change in the price of fuel may change the price structure such that bids that may have seemed excessive may now make sense.

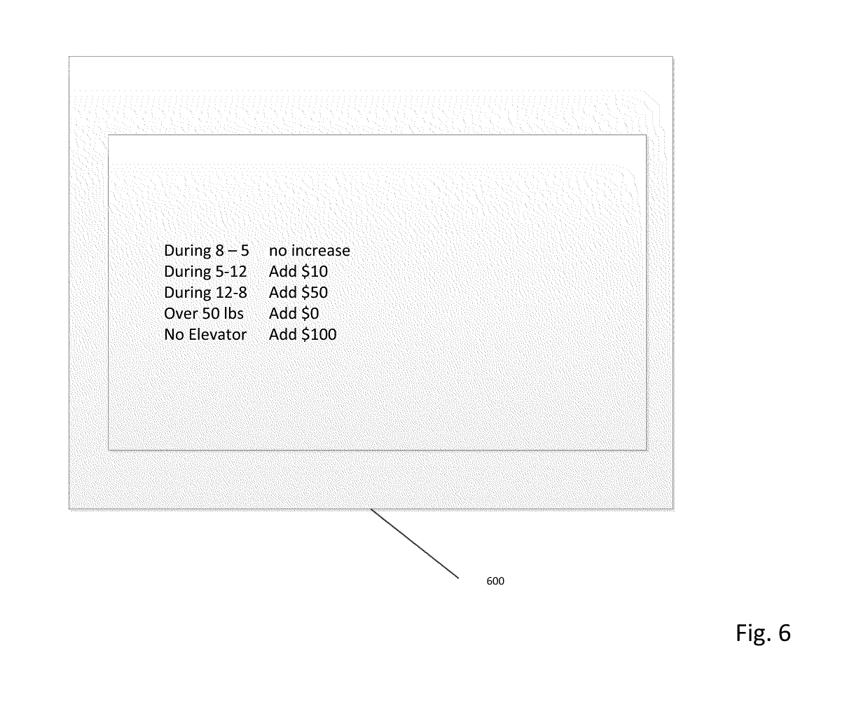

In some additional embodiments, the drivers may be able to set up standard response to routine queries. FIG. 6 may illustrate an input screen for common moving quotes. In this way, the response 700 may be virtually instantaneous for many common situations. For example, for moves during a given window for a given distance, a set price may be provided. Similarly, if the pickup and delivery are during common hours, the price may be less but if the pickup up or delivery is during odd time, the price may be higher. Other relevant factors that may be used may include weight, available parking, door width, etc. In some embodiments, the data from the moving database may be used to formulate the quotes. For example, the moving database may indicate there is one service elevator and it requires $50 to use the elevator for 1 hour. Such data may be used by the delivery personnel to either formulate a bid or to automatically respond to a request.

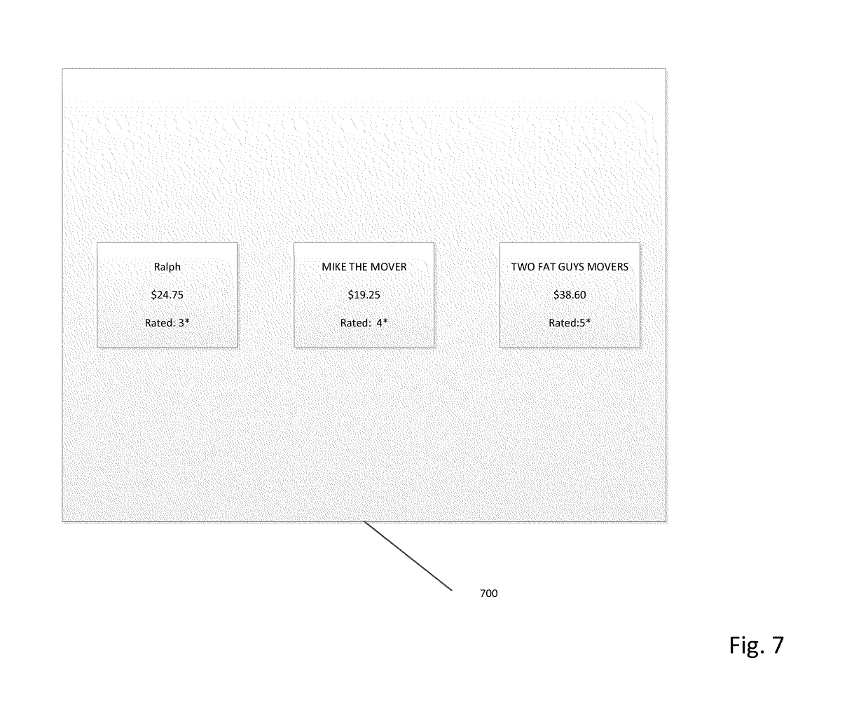

At block 450, the delivery responses may be communicated to the purchaser. FIG. 7 is an illustration of a quote display 700 reviewing delivery quotes. The quote display 700 may display a variety of information. At a minimum, it may display a name of the delivery company/independent contractor or username and a price. Other details that the driver believes are relevant may be displayed such as assuming there is a freight elevator, there will be parking available at the loading dock without a fee, etc. In some embodiments, the quotes may be received in real time. For example, the quote data may be promptly communicated to the drivers and the drivers responses may be communicated virtually instantaneously. In addition, the quote may contain information on the delivery company, such as if others have rated the delivery company or the quote may contain delivery statistics such as on-time percentage, any damage claims, number of complaints, number of successful deliveries, etc.

At block 460, one of the delivery responses may be accepted. The acceptance may be in a variety of ways, such as selecting on of the displayed bids, emailing the delivery personnel, texting the delivery personnel, calling the delivery personnel, paying the delivery on the third party web site, paying the delivery on the service provider web site, etc.

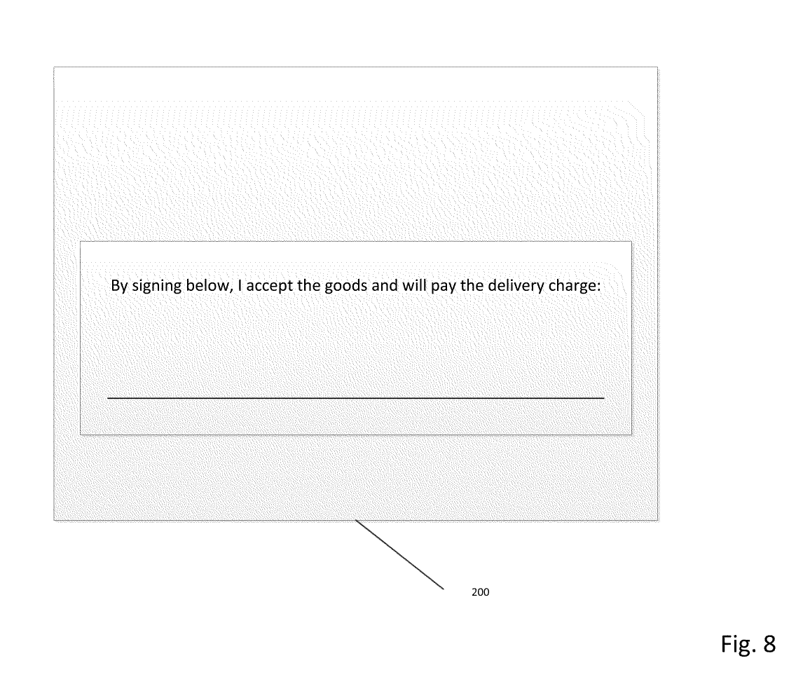

FIG. 8 is illustration of an acceptance by the second person display. In some situations, the second person may be required to provide a signature to create a contract with the delivery firm. In some embodiments, the second user may have an account set up in the system 113 which also may have payment information. In other embodiments, payment information may be required.

In some embodiments, a confirmation may be sent to the first user of the pickup time. The first user may have the option to accept the time when item will be picked up. In the alternative, the first user may be able to select a different time or reject a proposed time from the second user.

Logically, physical pickup and delivery occurs. The system 113 arranges the time and accepts payment for the pickup and delivery. The system 113 operator may keep a percentage of the pickup and delivery fee as a cost to use the service. The second party may pay for the pickup and delivery but in some embodiments, the first person may help out on the cost. In addition, a third party may also help cover the cost, such as a charitable organization, parents, government agencies, etc.

The system 113 may confirm delivery was made in a satisfactory way for a variety of reasons. From the perspective of the first person, in order to obtain the reward, the delivery may have to have been made and the goods may have to be accepted by the second person. From the second person perspective, there should be no charge or payment until the goods or services are safely delivered. Thus, the second person pays to an escrow account or to third party and the money us released when delivery is completed safely. From the delivery perspective, they may not be compensated until all the parties have completed their responsibilities or the delivery person has completed their part of the transaction. In short, some sort of verification is needed that the goods or services have been delivered and accepted such that fraud against the system (delivery person stealing the items 300, second person changing their mind, etc.) may be prevented.

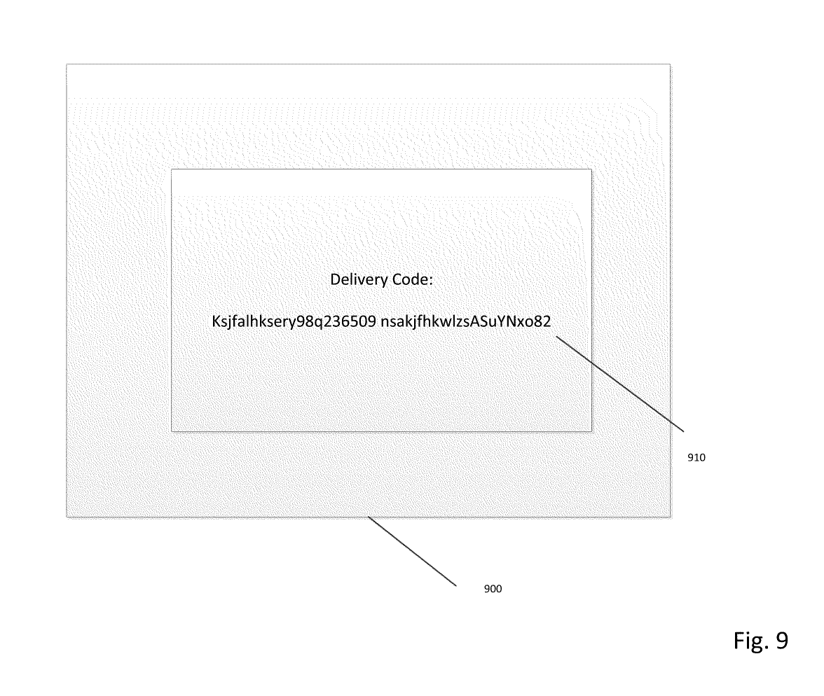

The system 113 may create codes that may be used to assist the system. The codes may be numbers, letters, shapes, encrypted sequences or commonly used codes such as QR codes. FIG. 9 may be a sample display 900 of a code 910. As one example, the second user may be emailed a code 910, and the delivery driver may need to scan or enter the second code 910 to prove that the delivery was made and the goods or services were accepted. In another example, the delivery person may be emailed a code 910 and the first person may enter the code 910 to ensure the delivery person is the person actually selected to pick up the goods. Similarly, the second person may verify the driver in a similar way using communicated code 910.

In another aspect, users may have their own code 910 and may pay for items 300 using the codes. For example, the second user may pay the delivery person by having the driver scan the code 910. In this way, physical transfer of money may never occur and both the giver and receiver will not have to be concerned about having physical currency.

In another aspect, a user may set up the code 910 in advance to contain payment information and delivery information. In this way, a user only has to enter their code 910 and payment information and desired delivery information may already be entered into the system 113 and communicated to other users.

For the delivery personnel, codes 910 may be used as a way to learn about the delivery service. A code 910 may be on the side of a truck and outsiders may scan the code 910 to obtain more information about the delivery service. Further, the codes 910 may link to a form which may already have the all movers' data and/or all other movers data located nearby, allowing the delivery to be easily requested.

In operation, the money for the movers may be held by a third party. The money may not distributed until the item has been accepted by the second user. In exchange for the risk of holding the money and for matching the first and second party together, the third party such as the operator of the system 113 may keep a portion of the money paid for moving expenses.

Referring again to FIG. 1, at block 150, if the item 300 has been accepted by the second user, a reward 1000 may be offered to the first user. FIG. 10 may illustrate a sample reward 1000. The reward 1000, like any reward, may take on a variety of forms and a variety of values. As an example and not a limitation, the reward 1000 may be a coupon, a rebate, a certificate, a credit on an account, a debit on an account, a check, a discount percentage, etc. In some embodiments, no interest will accrue on a purchase on the redeemable amount until the preset period is expired. For example, if first person is entitled to a $50 reward for donating a sofa and the user purchases a new sofa for $900, no interest would accrue on the $50 of the $900 for any preset period of time, such as 6 months as an example and not limitation.

In some embodiments, the reward 1000 may be for a same category of good as was donated. For example, if a person donated a couch, the reward 1000 may be for a discount on a new couch. The concept is that the person donated or sold at a low price a couch and will need a new couch. In yet another embodiment, the reward 1000 may be for a same brand of good as was donated. For example, if a first person donated a Sony television, the award may be for a discount on a new Sony television. In some embodiments, the reward 1000 may be for users getting rid of one brand toward another (for example: only user donated Android® phones will be entitled to get reward for another operating system or brand such as iPhones®).

In another embodiment, the reward 1000 may be for one or more of a predetermined set of retailers. As an example, the retailers may be advertised as offering the reward 1000 if the first user makes a donation. The advertisers receive significant advertising and sales from the promotion. At the same time, the advertiser also receive increased sales. Thus, the advertisers will likely be willing to offer discounts or rewards to be part of the program. In some embodiments, there may be a predetermined duration for the reward 1000. In this way, consumers will be encourage to use the reward 1000 and spend money with the participating retailers.

In some embodiments, the reward 1000 may be a check. The check may be mailed or may be communicated electronically to the account of a user. Similarly coupons or discounts may be physically mailed or electronically communicated to the first party. In some embodiments, codes are used to provide the rewards 1000. The code may be used at a retailer to provide the reward 1000. For example, the code may be on an electronic device of the first party and the code may be scanned by the retailer to obtain the discount. In another aspect, the code may be on the new item in the store and first user may scan it to get a reward. Further, the user may be able to pay for the item and order delivery instead of waiting in line.

In some embodiment, the reward 1000 may be communicated from a central system 141. In another embodiment, the reward may be communicated from a portable computing device of the driver 101. The rewards 1000 may be used at retailers physical locations or may be used at online retailers. The retailers may be reviewed online as well as the offers available from each retailer. For example, a first retailer may offer 30% off while a second retailer may offer $5 off.

The system 113 may have a variety of embodiments with the blocks performed in a variety of orders. In one embodiment, a person posts an old item 300, gives the old item 300 away, buys a new item 300 and gets a rebate within predetermined time period. In another embodiment. a person may posts an old item 300, buy a new item 300, gives the old item 300 away and gets a reward 1000 within predetermined time period. In yet another embodiment, a person may buy a new item 300, post an old item 300 to be given away, gives the old item 300 away and gets a reward 1000 within predetermined time period. The reward 1000 may take on a variety of forms from discount percentages to monetary grants.

User profiles may be created for first and second users. For first users, the profile may contain an address, items 300 donated, value and kind of items 300 donated, ways to accept rewards 1000 and success in offering items 300. For second users, the profile may contain an list of items 300 searched, an address, a manner of paying for items 300 and delivery, the value and kind of items 300 received, etc. The profiles may subject to additional analysis to make prediction about users that may have a specific item 300 to donate or who may be interested in a specific item in a specific location. Further, the data may be further analyzed to determine a relative affluence of users which may be useful in advertising and selling items 300.

### Computer System

As mentioned previously, the complexity of the system 113 make computing devices necessary. The system 113 has to accomplish a variety of functions, from tracking money, to tracking delivery rankings, to creating codes. FIG. 11 may be a high level illustration of some of the elements a sample computing system 113. The computing system 113 may be a dedicated computing device 141, a dedicated portable computing device 101, an application on the computing device 141, an application on the portable computing device 101 or a combination of all of these. FIG. 11 may be a high level illustration of a portable computing device 101 communicating with a remote computing device 141 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 101 may be a device that operates using a portable power source 155 such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 110 to communicate sounds.

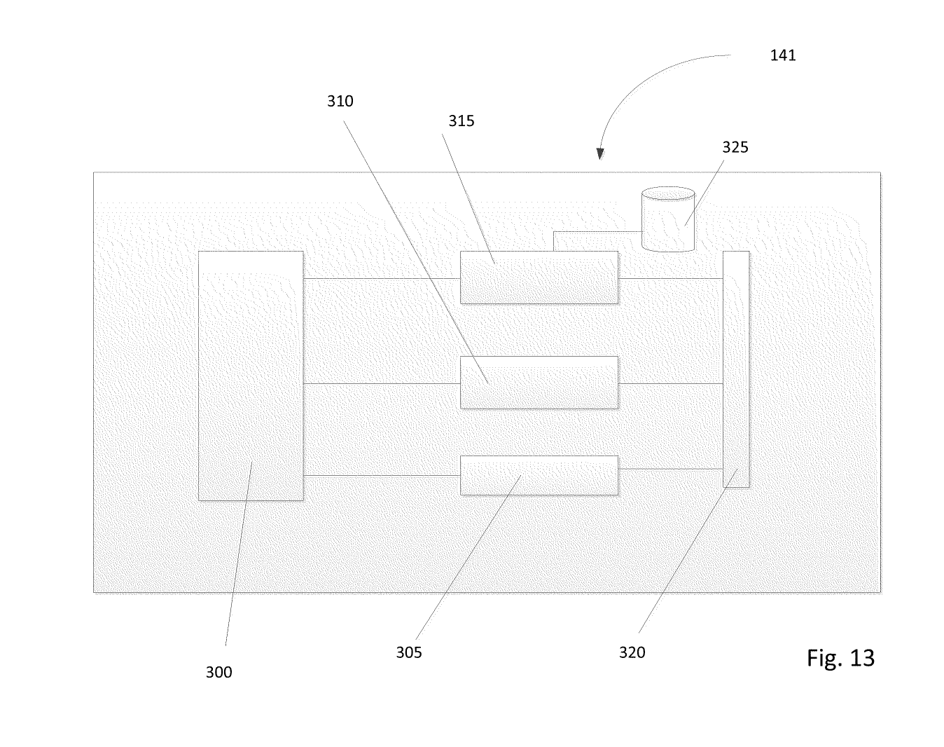

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a communication network 121 such as cellular service, through the Internet, through a private network, through Bluetooth, etc. A delivery person 103 may use a portable computing device 101 as may any of the first persons and second persons. FIG. 12 may be a simplified illustration of the physical elements that make up a portable computing device 101 and FIG. 13 may be a simplified illustration of the physical elements that make up a server type computing device 141.

FIG. 12 may be a sample portable computing device 101 that is physically configured according to be part of the system. The portable computing device 101 may have a processor 151 that is physically configured according to computer executable instructions. It may have a portable power supply 155 such as a battery which may be rechargeable. It may also have a sound and video module 160 which assists in displaying video and sound and may turn off when not in use to conserve power and battery life. The portable computing device 101 may also have volatile memory 165 and non-volatile memory 170. There also may be an input/output bus 175 that shuttles data to and from the various user input devices such as the microphone 106, the camera 108 and other inputs 102, etc. It also may control of communicating with the networks, either through wireless or wired devices. Of course, this is just one embodiment of the portable computing device 101 and the number and types of portable computing devices 101 is limited only by the imagination. The portable computing device 101 may act as a dedicated device to implement the method or may be a part of a computing system or may be installed in the driver's truck or be GPS or the screen of any type in the car.

The physical elements that make up the remote computing device 141 may be further illustrated in FIG. 13. At a high level, the computing device 141 may include a digital storage such as a magnetic disk, an optical disk, flash storage, non-volatile storage, etc. Structured data may be stored in the digital storage such as in a database. The computing device 141 may be a type of server and may have a processor 300 that is physically configured according to computer executable instructions. It may also have a sound and video module 305 which assists in displaying video and sound and may turn off when not in use to conserve power and battery life. The server 141 may also have volatile memory 310 and non-volatile memory 315.

The database 325 may be stored in the memory 310 or 315 or may be separate. The database 325 may also be part of a cloud 111 of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local portable computing device 101 and in other embodiments, the application may be remote 141. Of course, this is just one embodiment of the computing devices 141 and the number and types of portable computing devices 101 is limited only by the imagination.

As a result of the system 113, a new economic model is created. Unwanted items 300 may no longer be thought of as a nuisance but may be thought of as an opportunity to gain rewards. Similarly, attempting to schedule pickup and delivery of items 300 no longer has to be an endless series of emails, calls and comparison shopping as the system 113 may collect and present a plurality of delivery personnel and related pricing. Similarly, for people looking for items 300, the need to troll bulletin boards and thrift shops all while attempting to determine how to get the items 300 home will be eliminated. The system 113 may be intelligent and create a moving database of relevant information about moving in various locations and may create user profiles for first and second users, which may have a variety of uses.

The detailed description of the various embodiments is not intended to be limiting but is simply to illustrate some examples of how the system 113 may be created as it would be impossible to describe all the possible variations of the system 113 and how to make the system 113. Certainly, there are additional manners of creating the system 113 and different/additional embodiments of the system 113 that are possible and are contemplated without deviating from the spirit of the system 113.

1. A computerized method of accepting an item for virtually no cost and offering a reward comprising:
Receiving an item for virtually no cost from a first user;
Storing the item in a memory;
Displaying the item in an electronic format;
Receiving a selection of the item by a second user;
Arranging for transportation of the item from the first user to the second user;
If the item has been accepted by the second user, offering a reward to the first user.

2. The method of claim 1, further comprising placing item on hold after receiving payment from the second user for the item(s) and/or delivery of the item(s).

3. The method of claim 1 wherein arranging for transportation comprises:
Determining a pick up location for the item wherein the pickup location is determined from an input of the first user;
Determining a destination location for the item wherein the destination location is determined from an input from the second user;
Determining a pickup time window and a delivery time window;
Communicating the pickup location, destination location, pickup window and delivery window to a plurality of drivers;
Receiving a plurality of delivery responses from the plurality of drivers wherein the delivery responses comprise a price;
Communicating the delivery responses to the purchaser;
Receiving an acceptance or rejection by the second party; and
Receiving the payment for delivery.

4. The method of claim 3, wherein the first user accepts the time when item will be picked up.

5. The method of claim 3, wherein the money for the movers is held by a third party and is not distributed until the item has been accepted by the second user.

6. The method of claim 3, wherein the third party keeps a portion of the money paid for moving expenses.

7. The method of claim 1, wherein the reward is at least one selected from a group consisting of a coupon, a rebate, a certificate, a credit on an account, a debit on an account, a reward, a discount percentage

8. The method of claim 1, comprising issuing a reward upon posting item.

9. The method of claim 1, wherein no interest will be applied on the redeemable amount until the preset period is expired.

10. The method of claim 1, further comprising advertising for the retailer where a discount is available on the electronic display.

11. The method of claim 1, wherein codes are used to provide the reward and is used to confirm delivery.

12. The method of claim 1, wherein retailers that offer rewards may be reviewed online.

13. The method of claim 1, wherein a room layout may be set up online.

14. The method of claim 1, wherein video chat is available to check the item(s) condition.

15. A computerized method of accepting an item for virtually no cost goods and offering a reward comprising:
At a retailer, offering a reward if a first user offers to give an item for virtually no cost;
Making a sale to the first user;
Receiving an item for virtually no cost from a first user;
Storing the item in a memory;
Displaying the item in an electronic format;
Receiving a selection of the item by a second user;
Arranging for transportation of the item from the first user to the second user; and
Once the donation item has been accepted by the second user, issuing a reward to the first user.

16. The method of claim 15 wherein arranging for transportation comprises:
Determining a pick up location for the item wherein the pickup location is determined from an input of the first user;
Determining a destination location for the item wherein the destination location is determined from an input from the second user;
Determining a pickup time window and a delivery time window;
Communicating the pickup location, destination location, pickup window and delivery window to a plurality of drivers;
Receiving a plurality of delivery responses from the plurality of drivers wherein the delivery responses comprise a price;
Communicating the delivery responses to the purchaser;
Receiving an acceptance or rejection by the second party; and
Receiving the payment for delivery.

17. A computerized method of accepting an item for virtually no cost goods and offering a reward comprising:
Making a sale to the first user at a retailer;
Offering a reward if a first user offers to give an item for virtually no cost;
Receiving an item for virtually no cost from a first user;
Storing the item in a memory;
Displaying the item in an electronic format;
Receiving a selection of the item by a second user;
Arranging for transportation of the item from the first user to the second user; and
Once the donation item has been accepted by the second user, issuing a reward to the first user.

18. The method of claim 17 wherein arranging for transportation comprises:
Determining a pick up location for the item wherein the pickup location is determined from an input of the first user;
Determining a destination location for the item wherein the destination location is determined from an input from the second user;
Determining a pickup time window and a delivery time window;
Communicating the pickup location, destination location, pickup window and delivery window to a plurality of drivers;
Receiving a plurality of delivery responses from the plurality of drivers wherein the delivery responses comprise a price;
Communicating the delivery responses to the purchaser;
Receiving an acceptance or rejection by the second party; and
Receiving the payment for delivery.
